(19) United States
(12) Patent Application Publication
(10) Pub. No.: US 2011/0273510 A1
(43) Pub. Date: Nov. 10, 2011

(54) PRINTING APPARATUS

(75) Inventors: Masahiro Sugimoto, Yokohama-shi (JP); Akira Kida, Yokohama-shi (JP); Masaharu Ueda, Tokyo (JP)

(73) Assignee: CANON KABUSHIKI KAISHA, Tokyo (JP)

(21) Appl. No.: 12/965,763

(22) Filed: Dec. 10, 2010

(30) Foreign Application Priority Data
May 6, 2010 (JP) 2010-106715

(51) Int. Cl. B41J 2/165

(52) U.S. Cl. 347/22

(57) ABSTRACT

A plurality of recording head units are supported by a holder in an integrated manner. The recording head units and pairs of rollers which hold a sheet are arranged alternately along a sheet conveying direction. An elastic member is disposed in a clearance between the holder and each of the recording head units supported by the holder in an elastically deformed manner to form an airtight seal. The airtight seal prevents upward leakage, from the clearance, of the humidifying gas introduced into the narrow space to which ink nozzles of the recording head units are exposed.

### BACKGROUND OF THE INVENTION

1. Field of the Invention

The present invention relates to a printing apparatus which includes a recording head to which humidifying gas is supplied.

2. Description of the Related Art

Highly accurate ink discharge performance is required for the formation of high-definition images with a printing apparatus.

To achieve such highly accurate ink discharge performance, a technique for supplying humidifying gas near ink nozzles to prevent drying of the nozzles has been widely employed. Japanese Patent Laid-Open No. 2006-44021 discloses a technique for supplying humidifying gas to a narrow space defined between a sheet and a holder which holds a recording head for efficient humidification only in the neighborhood of ink nozzles. In the disclosed device, the sheet is electrostatically-sucked or vacuum-sucked and supported.

In the above-disclosed structure, the sheet is electrostatically-sucked or vacuum-sucked and supported from a back surface thereof with a suction belt or a suction roller. However, since the sheet is supported only from the back surface, it is possible that sheets of certain types or having certain properties might not be sufficiently sucked. Especially in the device disclosed in Japanese Patent Laid-Open No. 2006-44021, since highly humid humidifying gas is introduced into a suction belt or a suction roller, electric charge leaks away from a suction surface due to the humidity to thereby greatly impair the supporting performance of the sheet. As a result, a sheet with high rigidity and heavy curl may be lifted against the insufficient suction force at the back surface thereof. The image quality may be impaired in the lifted portion of the sheet. The sheet may even touch the recording head if the lifted amount is large. If a sheet is vacuum-sucked and supported in the device disclosed in Japanese Patent Laid-Open No. 2006-44021, the introduced humidifying gas is absorbed by the vacuum before the sheet is being sucked. As a result, efficiency in humidification is significantly impaired.

The present invention has been made in view of the aforementioned circumstances. The present invention provides a recording apparatus capable of reliably supporting sheets of any types or having any properties during a process of introducing humidifying gas between recording heads and a sheet to prevent drying of ink nozzles and capable of efficiently using the humidifying gas.

A pair of rollers which holds a sheet from both sides may be employed as a unit for reliably supporting and conveying the sheet at a recording position. However, one of the pair of rollers disposed at the recording head side of the sheet may disturb the flow of the introduced humidifying gas. A part of the disturbed flow of the gas is directed upward, which may cause the humidifying gas or ink mist produced from the ink nozzles during the recording to leak through an even small clearance between the recording head and a support member which supports the recording head. Japanese Patent Laid-Open No. 2006-44021 discloses that a support member la and a nozzle face of a recording head are formed as a continuous flat surface. Such a structure may include a small clearance between the support member la and the nozzle face. Such a small clearance, however, does not become a problem in the structure disclosed in Japanese Patent Laid-Open No. 2006-44021 because no roller is disposed at the recording head side of the sheet and thus no seriously disturbed flow of the gas may be created.

### SUMMARY OF THE INVENTION

According to an aspect of the present invention, an apparatus includes a first recording head unit and a second recording head unit arranged in a conveying direction, each of the recording head units including ink nozzles; a conveying unit which includes a pair of rollers consisting of a first roller and a second roller, the pair of rollers holding the sheet between a recording position of the first recording head unit and a recording position of the second recording head unit, the first roller being disposed between the first and second recording head units; a holder which holds the first and second recording head units; a sealing member which is disposed in a clearance between the holder and at least one of the first and the second recording head units to form an airtight seal; and a humidifying unit which supplies humidifying gas to a narrow space where the ink nozzles of the first and the second recording head units are exposed.

Further features of the present invention will become apparent from the following description of exemplary embodiments with reference to the attached drawings.

### BRIEF DESCRIPTION OF THE DRAWINGS

FIG. 1 is a perspective view of an entire printing apparatus according to an embodiment.

FIG. 2 is a sectional view of an internal structure of the printing apparatus.

FIG. 3 schematically illustrates a humidifying unit.

FIG. 4 is a perspective view of a recording unit with recording head units mounted thereon.

FIG. 5 illustrates a holder with the recording head units removed therefrom.

FIG. 6 is a sectional view of an inside of the recording unit seen from a second direction.

FIG. 7 is a sectional view of the inside of the recording unit seen from a first direction.

### DESCRIPTION OF THE EMBODIMENTS

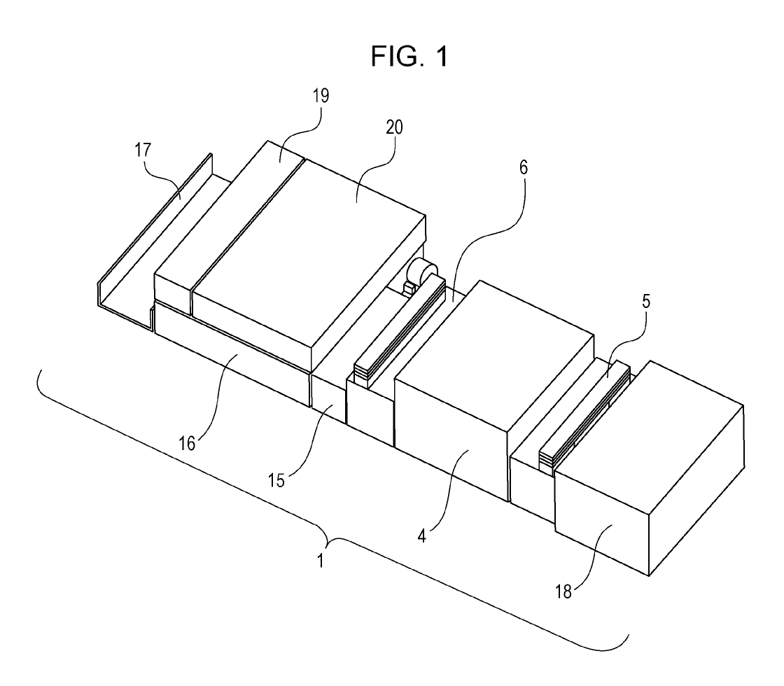

FIG. 1 is a perspective view of an overall structure of a recording apparatus relating to an embodiment of the present invention. A recording apparatus 1 includes a paper feeding unit 18, a supply unit 5, a recording unit 4, a recovery unit 6, a cutting unit 15, a drying unit 16, an ink tank 20, a controller 19 and a paper discharge unit 17 arranged from the upstream side to the downstream side along a conveyance direction of a sheet during the recording. At an arbitrary position on the sheet conveyance path, a side toward the paper feeding unit 18 is referred to as the “upstream” and the opposite side is referred to as the “downstream.”

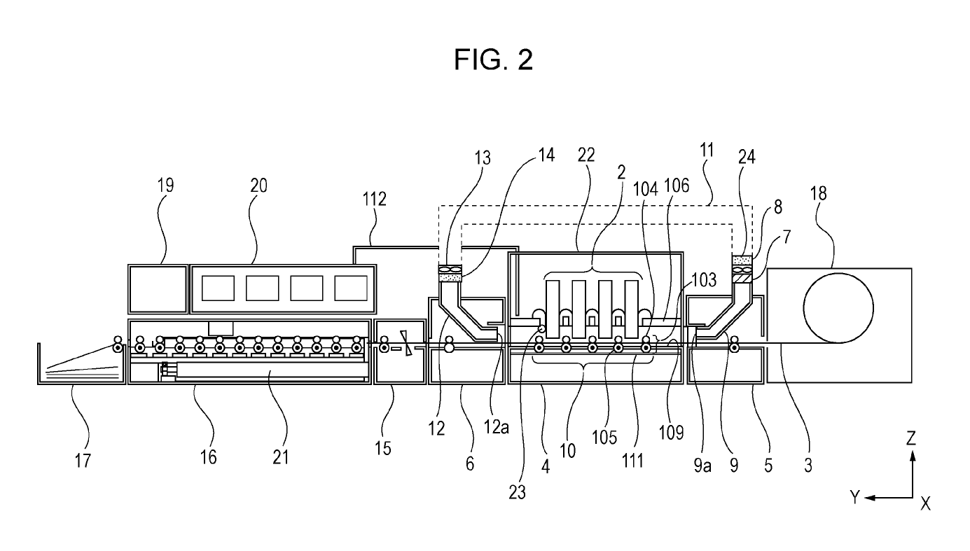

FIG. 2 is a sectional view of an internal structure of the recording apparatus 1 illustrated in FIG. 1. The paper feeding unit 18 rotatably supports a rolled-up sheet 3. Although the sheet 3, which is a recording medium, is a continuous sheet in the present embodiment, the sheet 3 may be a cut sheet. The paper feeding unit 18 includes a paper feeding mechanism which pulls out a sheet 3 and supplies the same to the downstream of a sheet conveying direction (hereinafter, this direction will be referred to as a “Y direction” or “the first direction”).

The recording unit 4 includes a plurality of recording head units 2, each of which corresponds to one of the ink colors. Each of the recording head units 2 includes a recording head section which has a nozzle face constituted by a linear array of ink nozzles. The recording head unit 2 also incorporates a circuit board which drives and controls the ink nozzles, and a part of wire harnesses connected to the circuit board. A plurality of recording head units 2 are supported by the holder 106 in an integrated manner. Ink of each color is stored in the corresponding ink tank 20 and is supplied therefrom to the corresponding recording head unit 2 via an ink tube 112. Although the ink tanks 20 herein are provided separately from the recording head unit 2, the recording head section and the ink tank 20 may be provided in an integrated manner in each of the recording head units 2.

Although four recording head units 2 corresponding to four colors of C, M, Y and K are provided in the present embodiment, the number of colors is not limited thereto. Each of the recording head units 2 is a linear recording head constituted by an array of inkjet ink nozzles disposed over the maximum width of the sheet expected to be used. The array of the ink nozzles is disposed along a direction perpendicular (at a right angle in the present embodiment) to the first direction (hereinafter, this direction will be referred to as an “X direction” or “the second direction”). The array of the ink nozzles may be constituted by a unit number of nozzle tips arranged over the width direction in a regular arrangement, such as a staggered arrangement or in a linear arrangement. The inkjet system may be, for example, a thermal inkjet system, a piezoelectric inkjet system, an electrostatic inkjet system and a MEMS inkjet system.

A sheet conveying path is provided across the recording unit 4 so as to face the recording head units 2. The recording unit 4 includes a sheet conveying unit 10 which conveys the sheet along the sheet conveying path. The recording head units 2 and the sheet conveying unit 10 are accommodated in a housing 22 of the recording unit 4.

The sheet conveying unit 10 includes a plurality of (five in the present embodiment) pairs of rollers 103 and a platen 109. The pairs of rollers 103 are disposed along the sheet conveying path and support the sheet from both sides. Each of the pairs of rollers 103 is constituted by an upper, first roller 104 (pinch roller) and a lower, second roller 105. The second roller 105 is driven to rotate and the first roller 104, which has no driving force, follows the rotation of the second roller 105. The platen 109 and a plurality of second rollers 105 are supported on a base 111. The platen 109 is divided into a plurality of sections along the direction of the sheet. Each of the divided sections of the platen 109 is located between adjacent second rollers 105 and faces each of the five recording head units 2. That is, the second rollers 105 are rotatably embedded in openings formed in the platen 109. Since the clearances between the second rollers 105 and the platen 109 are small, leakage of air through the clearances is small. The behavior of the sheet 3 during the conveyance is stable since the sheet 3 is supported at both the upstream and downstream sides by the pairs of rollers 103 at each of the positions facing the recording head units 2 (i.e., recording positions) and also supported by the platen 109. The sheet is introduced in a stable manner especially when the sheet 3 is first introduced because a leading end of the sheet 3 passes through a plurality of holding positions in a short period and thus lifting of the leading end of the sheet is prevented.

The base 111 and various structures are provided below the platen 109. During the recording process, the sheet 3 itself forms a part of an airtight seal in a lower portion of the narrow space. When the sheet 3 is not on the support surface and no recording is made, the platen 109 forms an airtight seal in the lower portion. Although small clearances are left between the platen 109 and the second rollers 105 embedded therein, airtightness is provided from below by the base 111 and other structures forming a part of the airtight seal. In this manner, the narrow space to which airtightness is provided from both above and below is formed.

Humidification gas generated by the supply unit 5 is supplied to the inside of the recording unit 4. Although the gas herein is air, any gaseous materials other than air may be used. The humidifying gas supplied to the recording unit 4 is recovered by the recovery unit 6. The humidifying gas recovered by the recovery unit 6 at least partially flows back to the supply unit 5 via a return duct 11 for reuse. A hygrometer 23 for measuring humidity of the gas is provided in the narrow space in the recording unit 4 near the array of the ink nozzles of the most downstream recording head unit 2. As the humidifying gas flows from the upstream to the downstream, the humidity increases gradually from upstream to the downstream in the narrow space. When the hygrometer 23 detects the desired humidity at the most downstream position, it can be considered that the desired humidity has been achieved in the entire narrow space.

The supply unit 5 generates humidifying gas and then supplies the same to the vicinity of the array of the ink nozzles of the recording head. The supply unit 5 is mainly constituted by a supply duct 9, a humidifying unit 7, a supply fan 8 and a supply-side filter 24. Some of a plurality of conveying rollers of the sheet conveying unit 10 are disposed below the supply duct 9 and the sheet conveyance path passes through the rollers. An end of the supply duct 9 is formed as a supply port 9a from which the humidifying gas is blown out. The supply port 9a is provided to supply the humidifying gas to the most upstream recording head unit 2 in the narrow space. The supply fan 8 directs the humidifying gas to flow from the upstream to the downstream along the conveyance direction in the narrow space.

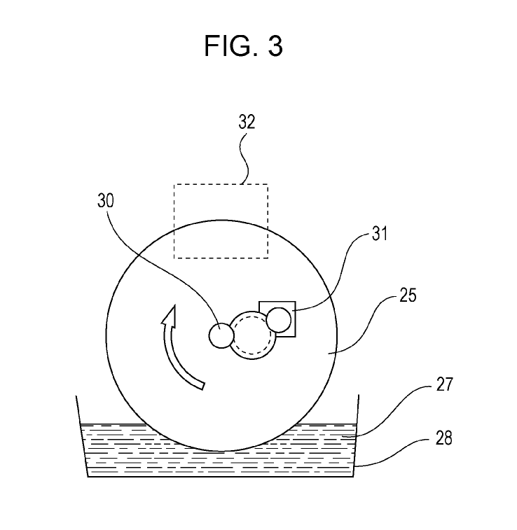

The humidifying unit 7 generates the humidifying gas through evaporation. FIG. 3 schematically illustrates a configuration of the humidifying unit 7. The humidifying unit 7 includes a disc 25 which has a highly-absorptive water-absorbing member attached thereto. The disc 25 is driven to rotate about a shaft 30 by a driving mechanism 31. A lower portion of the disc 25 is soaked in water which is contained in a tank 28. As the disc 25 rotates, the entire water-absorbing member gradually absorbs water. In the supply unit 5, dust particles and foreign objects are removed from the gas by the supply-side filter 24 and the cleaned gas is introduced into the humidifying unit 7 by the supply fan 8. Since the introduced gas passes through the humidifying unit 7 while hitting a part of the rotating disc 25 at a frictional section 32, a part of the water absorbed by the water-absorbing member is vaporized to produce humidifying gas which is humidified. Humidification capacity of the humidifying unit 7 can be controlled through adjustment of the rotational speed of the disc 25 and the rotational speed of the supply fan 8. The controller 19 controls the humidifying unit 7 to operate so that the humidifying gas of desired humidity might be generated through feedback-control of the humidifying unit 7 on the basis of the humidity detected by the hygrometer 23. The humidifying unit 7 is not limited to that of the present embodiment. Alternatively, a humidifying unit may be any known unit, such as a vaporizer, a water sprayer and a steam generator, may be used. A vaporizer may employ, in addition to the rotating disc system of the present embodiment, a permeable film system, a dropping permeation system and a capillary tube system. The water sprayer may employ an ultrasonic system, a centrifugal system, a high-pressure spray system and two-fluid spray system. The steam generator may employ a steam pipe system, an electric heat system and an electrode system.

The humidifying gas generated by the humidifying unit 7 flows through the supply duct 9 and is blown out of the supply port 9a. The blown-out humidifying gas is supplied to the vicinity of the array of the ink nozzles of the most upstream recording head 2 among the plurality of recording head units 2. The supplied humidifying gas flows from the upstream to the downstream along the sheet conveyance direction in the narrow space while humidifying the ink nozzles to prevent evaporation of the ink in the nozzles and drying of the nozzles.

The recovery unit 6 recovers the humidifying gas supplied to the recording unit 4. The recovery unit 6 is mainly constituted of a recovery duct 12, a recovery fan 13 and a recovery filter 14. Some of a plurality of conveying rollers of the sheet conveying unit 10 are disposed below the recovery duct 12 and the sheet conveyance path passes through the rollers. An end of the recovery duct 12 is formed as a recovery port 12a from which the humidifying gas is sucked. The recovery port 12a is disposed at a position to suck the humidifying gas which has flowed through the narrow space and has passed through the most downstream recording head unit 2.

Suction force which creates a flow of the gas in the recovery duct 12 is generated by the rotation of the recovery fan 13. The recovery filter 14 mainly removes ink mist. The recovery duct 12 is connected to the return duct 11 via the recovery fan 13. The return duct 11 is connected to the humidifying unit 7 and the supply duct 9 through the supply-side filter 24. That is, the humidifying gas recovered from the recording unit 4 is made to flow back to the supply unit constituted by the return duct 11 through the return duct 11 for reuse. Since the gas introduced into the humidifying unit 7 for reuse previously has certain high humidity, efficiency in humidification of the total device increases. Alternatively, a part of the humidified air recovered from the recovery duct 12 is made to flow back for reuse and the rest may be exhausted inside the recording apparatus 1. If humidity of the humidified air at the time of being recovered to the recovery duct 12 is as small as that of the inside of the recording apparatus 1, since no large increase in efficiency in humidification is expected, the humidified air may not be reused. In this case, no return duct 11 may be provided.

The cutting unit 15 includes a cutter mechanism which cuts the continuous sheet 3 into a predetermined size after the sheet 3 is subject to the recording in the recording unit 4. The drying unit 16 is provided for drying ink on the cut sheet in a short time and includes a heater 21 and a plurality of conveying rollers arranged along the path. The paper discharge unit 17 accommodates the cut sheets exhausted from the drying unit 16. A plurality of sheets are accumulated in the paper discharge unit 17. The controller 19, which controls and drives the entire recording apparatus 1, includes a CPU, memory and various I/O interfaces.

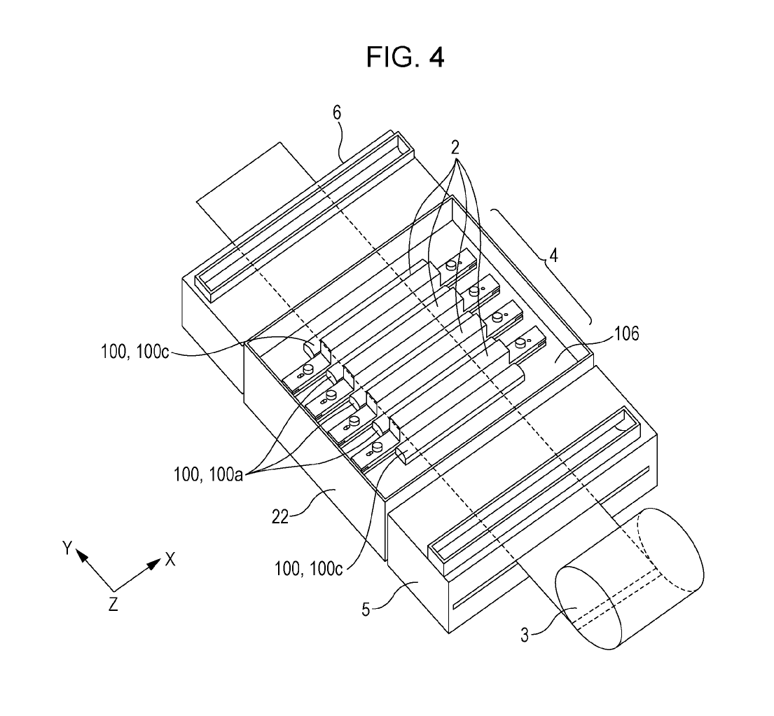

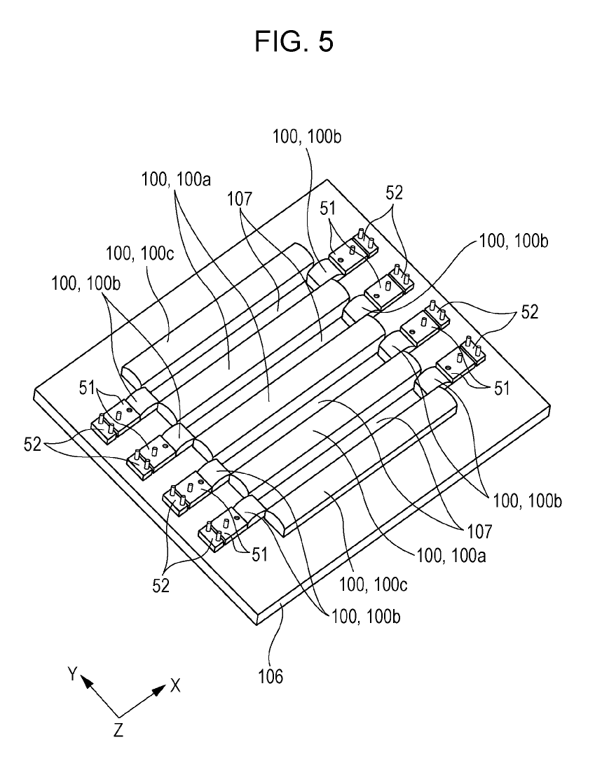

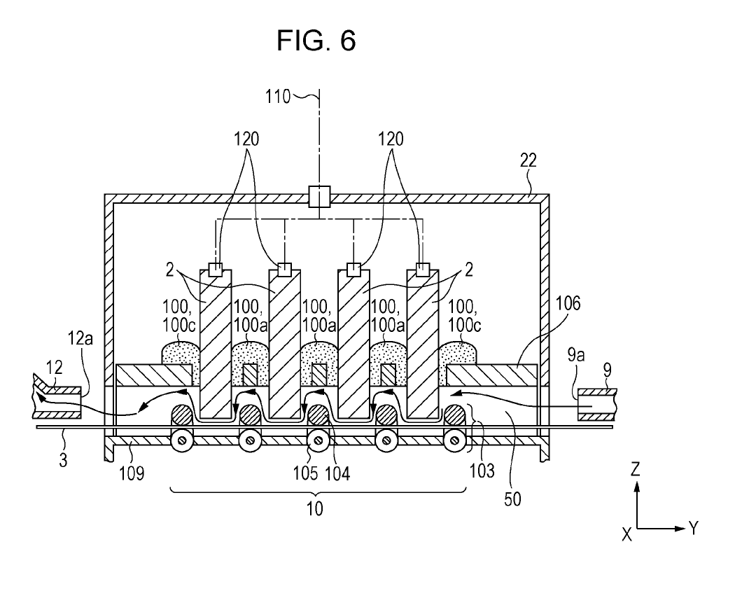

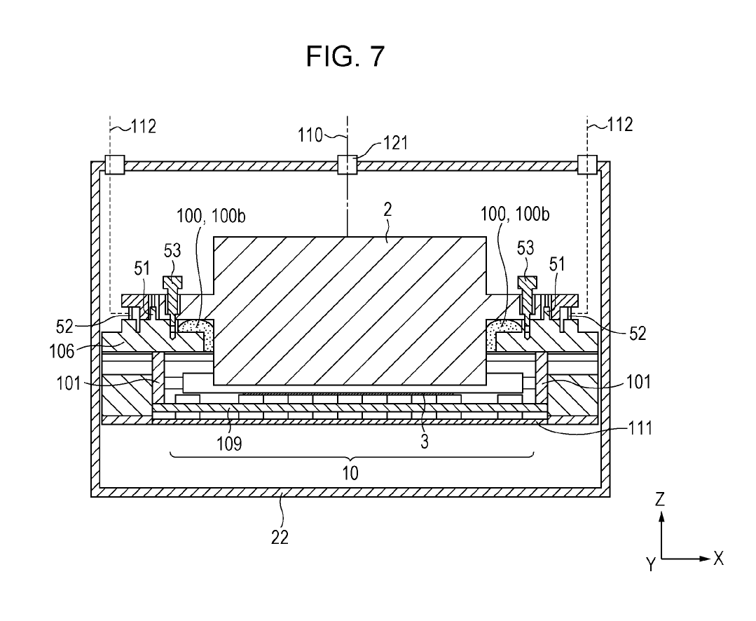

Next, the further details of the recording unit 4 will be given. FIG. 4 is a perspective view of a recording unit 4 with recording head units 2 mounted thereon. FIG. 5 is a perspective view of the holder 106 with the recording head units 2 removed therefrom. FIG. 6 is a sectional view of the inside of the recording unit 4 seen from a second direction. FIG. 7 is a sectional view of the inside of the recording unit 4 seen from a first direction.

A plurality of recording head units 2 are supported by the holder 106 in an integrated manner and each of the recording head units 2 can be individually mounted on and removed from the holder 106. The holder 106 has four insertion openings 107 in which the four recording head units 2 are inserted and supported along a vertical direction (this direction will be referred to as a “Z direction” or “the third direction”) in which the recording head units 2 oppose the sheet 3. In each insertion opening 107, the opening widths of the insertion opening 107 in the X and Y directions are larger than the width dimension of each of the recording head units 2. Thus, there will be a clearance between the insertion opening 107 and side surfaces of the recording head unit 2 inserted therein. The clearance serves as a play which facilitates mounting and removal of the recording head units 2. Thus, the recording head unit 2 is not accurately aligned with the holder 106 at the insertion opening 107. As described later, the recording head unit 2 is accurately aligned with and fixed to the holder 106 in two places, i.e., at both ends of the linear array of the ink nozzles arranged in the X direction.

Elastic members 100 are provided at inner peripheries of the insertion openings 107. The elastic members 100 are sealing members which are disposed between the recording head units 2 and the holder 106 in an elastically deformed manner to form an airtight seal in the clearance. The holder 106 and the elastic members 100 are formed of a material different from that of the holder. The holder 106 is highly rigid to enable alignment and fixation of the recording head units 2 while the elastic members 100 have desired elastic force with which they can be bent or compressed with elastic restoring force.

The elastic members 100 may be formed of any materials which do not crack when being bent or compressed and which can shield humidifying gas. Examples of the materials which can be used as the elastic members 100 may include rubbers, such as EPDM rubber, crude rubber, butyl rubber, chloroprene rubber, nitrile rubber, urethane rubber, silicone rubber, fluorine-containing rubber and ethylene-propylene rubber, and foams thereof. In addition, sufficiently flexible plastic materials may also be used.

The elastic members 100 as an example of a sealing member may be coated with a plastic material or other material to improve lubricity of the surface thereof. In this manner, the elastic members 100 can be easily mounted on and removed from the recording head units 2 and obtain improved water shielding property.

The elastic members 100 consist of first elastic members 100a, second elastic members 100b and third elastic members 100c.

The elastic members 100a to 100c are each of identical shape and disposed at a plurality of locations. Three first elastic members 100a are provided each between adjacent insertion openings 107. The width dimension of each first elastic member 100a in the Y direction is larger than the distance between adjacent insertion openings 107 when seen from the Z direction when the first elastic member 100a is in a non-compressed state (see FIG. 5). The first elastic member 100a partially protrudes inside the insertion opening 107. Each of the first elastic member 100a is provided to surround three rectangular surfaces (i.e., an upper surface and two side surfaces) of each of rectangular pillar-shaped components (which are rectangular in section when seen from the X direction) of the holder 106 located between adjacent insertion openings 107. The rectangular pillar-shaped component and the first elastic member 100a are fixed to each other on the three rectangular surfaces with a strong adhesive or double-sided tape. The rectangular pillar-shaped component and the first elastic member 100a can be fixed to each other on all three surfaces. Alternatively, however, they may be fixed to each other on any two surfaces or only on the upper surface. When the recording head unit 2 is placed in the insertion opening 107, the first elastic member 100a is compressed and elastically deformed between inner peripheral surfaces of the insertion opening 107 and the side surfaces of the recording head unit 2. In this state, the first elastic member 100a forms an airtight seal between the recording head unit 2 and the insertion opening 107. The first elastic member 100a is not fixed to a lower surface (i.e., a surface which faces the sheet 3) of the rectangular pillar-shaped component. This is to prevent interference between the first elastic member 100a and the first roller 104 in case of an unexpected removal of the first elastic member 100a from the lower surface or expansion of the first elastic member 100a over a design assumption. Another reason for not providing the first elastic member 100a on the lower surface is that the first elastic member 100a may narrow a distance between a head of the first roller 104 and the holder 106 and disturb the flow of the gas. Note that the portions of the first elastic member 100a disposed between adjacent rectangular pillar-shaped components may protrude downward over the lower surface of the holder 106 in a small amount because, in such portions, the first elastic member 100a hardly interferes with the head of the first roller 104.

Although the first elastic member 100a in the present embodiment forms an airtight seal in the clearance between the insertion opening 107 of the holder 106 and the recording head unit 2, the first elastic member 100a may, alternatively, form an airtight seal between adjacent recording head units 2 in a position above the holder 106.

Eight second elastic members 100b are provided each at both ends of the insertion openings 107 in the X direction in which the linear array of the ink nozzles are arranged. Each second elastic member 100b partially protrudes inside the insertion opening 107. Each second elastic member 100b is fixed to an upper surface and a side surface of the holder 106 at the insertion opening 107 with a strong adhesive and double-sided tape. When the recording head unit 2 is placed in the insertion opening 107, the second elastic member 100b is compressed and elastically deformed between inner peripheral surfaces of the insertion opening 107 and the side surfaces of the recording head unit 2. In this state, the second elastic member 100b forms an airtight seal between the recording head unit 2 and the insertion opening 107.

The third elastic members 100c are disposed at the most upstream and the most downstream insertion openings 107 among the four insertion openings 107. Each third elastic member 100c partially protrudes inside the insertion opening 107. Each third elastic member 100c is fixed to an upper surface and a side surface of the holder 106 at the insertion opening 107 with a strong adhesive and double-sided tape. When the recording head unit 2 is placed in the insertion opening 107, the third elastic member 100c is compressed and elastically deformed between an inner peripheral surface of the insertion opening 107 and a side surface of the recording head unit 2. In this state, the third elastic member 100c forms an airtight seal between the recording head unit 2 and the insertion opening 107.

As illustrated in FIGS. 5 and 7, each of the insertion openings 107 of the holder 106 includes positioning sections 51 at both ends of the linear array of the ink nozzles along the X direction. The positioning sections 51 are used for accurate positioning and fixation of the recording head unit 2. During the mounting of the recording head unit 2 on the insertion opening 107, the operator aligns the recording head unit 2 with the insertion opening 107 while a projection of the positioning section 51 and a recess of a fixing section are in engagement at both ends of the linear array of the ink nozzles of the recording head unit 2. Then, the operator inserts screws 53 in a screw hole of the fixing portion and a screw hole of the positioning section 51 and tightens the same to firmly fix the recording head unit 2 to the holder 106. In this manner, the recording head unit 2 is firmly fixed to the holder 106 in an accurate positional relationship in all the directions of X, Y and Z. Since the elastic members 100 are disposed in the clearance between the recording head unit 2 and the holder 106 in an elastically deformed manner, sufficient airtightness can be provided.

At the time of removing the recording head unit 2 for replacement or maintenance, the operator removes the screws 53 at both ends of the linear array of the ink nozzles and removes the recording head unit 2 upward. After the recording head unit 2 is removed, the elastic members 100 restore their original shapes. During the mounting and removal of the recording head unit 2, the elastic members 100 provided to surround the insertion opening 107 elastically deform and absorb excessive force. Thus, the elastic members 100 will not be removed from the holder 106 as the recording head unit 2 is moved upward and downward. The first elastic member 100a, which receives the largest force during the mounting and removal of the recording head unit 2, is formed from a single elastic material and is firmly fixed to the three surfaces (i.e., the upper surface and both side surfaces) of the rectangular pillar-shaped component located between adjacent insertion openings 107 of the holder 106. Thus, the first elastic member 100a is hardly removed from the holder 106 when being subject to the large force in the vertical direction.

As illustrated in FIG. 6, the pairs of rollers 103 and the recording head units 2 are arranged alternately along the conveyance direction of the sheet 3. That is, each of the upper, first rollers 104 of the pairs of rollers 103 is located between any adjacent two recording head units 2. The holder 106 supports the recording head units 2 at locations further distanced from the sheet 3 than the heads of the first rollers 104. In this manner, each of the recording head units 2 is supported in positional alignment with the holder 106 in the X, Y and Z directions. With this configuration, a gap (a 1-mm gap in the present embodiment) suitable for discharging ink is formed between the array of the ink nozzles of the recording head units 2 and a surface of the sheet 3. In addition, the recording head units 2 are located in the correct relative positions in the X and Y directions.

The recording unit 4 has the narrow space 50 to which the ink nozzles of the recording head units 2 are exposed. The humidifying gas is introduced into the narrow space 50 from the supply port 9a of the supply duct 9. The humidifying gas forms a flow of the gas which prevents drying of the ink nozzles in the narrow space 50. The narrow space is a flow path of the gas which is substantially airtightly sealed at upper, lower and side portions.

The upper portion of the narrow space 50 is defined by the lower surface of the holder 106, lower portions of the recording head units 2 and the elastic members 100 constituted by an elastic material. As described above, the elastic members 100 are sealingly disposed in the clearances between the recording head units 2 and the holder 106 to form an airtight seal in the narrow space 50.

As described above, the lower portion of the narrow space 50 is constituted by the platen 109 and the base 111 and various structures provided below the platen 109. As illustrated in FIG. 7, side portions of the narrow space 50 are defined by shield plates 101 which are provided at both sides of the holder 106 along the first direction. Lower portions of the shield plates 101 oppose the platen 109 in a non-contact manner with narrow clearances left therebetween.

As illustrated by arrows in FIG. 6, the humidifying gas blown out from the supply port 9a flows through a space between the upstream recording head unit 2 and the sheet 3 in the narrow space 50. The humidifying gas then flows through a space between the first roller 104 and the holder 106, through a space between a subsequent downstream recording head unit 2 and the sheet 3 and through subsequent speces. In this manner, the humidifying gas flows following a vertically serpentine path. The flow of the introduced humidifying gas is disturbed by the first rollers 104 and the disturbed flow of the gas is directed upward. With the upwardly directed flow, the humidifying gas or ink mist produced from the ink nozzles during the recording easily leak and diffuse upward through an even small clearance between the recording head and a support member which supports the recording head. Such diffusion is prevented by the elastic members 100 which form an airtight seal in the clearances. Without the elastic members 100, the gas in the narrow space may leak from the clearances and diffuse upward and cause the following problems:

(1) Parts which are not necessarily humidified are exposed to the humidifying gas leaking from the clearance and diffusing upward, which may form dew condensation. Dew condensation occurring in the circuit board and wiring of the recording head units may cause short circuits in the circuit or a part of the wiring. As a result, malfunctions may occur in the recording head units and, in the long run, metal parts may be corroded.

(2) Ink mist produced at the nozzles of the recording heads during the recording diffuses upward through the clearances between the holder and the recording heads, whereby ink contamination may be caused in the upper and side surfaces of the recording heads, and circuit boards and wiring associated with the recording heads. Since the ink mist diffuses together with the humidifying gas and adheres to the parts, the ink mist contains high moisture content and is thus hard to dry. As a result, the ink mist adhering to the upper surface and side surfaces of the recording heads remains wet, which may easily contaminate hands and clothes of the operator during replacement or maintenance of the recording heads. In addition, a large amount of ink mist adhering to and remaining wet on the circuit board or the wiring may cause the same problems as those caused by the dew condensation described above. According to the recording apparatus of the present embodiment, these problems can be prevented.

As illustrated in FIGS. 6 and 7, each of the four recording head units 2 includes a drawing port 120 through which wire harnesses 110 of an electric system of the recording head unit 2 is drawn out at positions not exposed to the narrow space 50. The wire harnesses 110 are connected to the circuit board incorporated in the recording head unit 2. The circuit board is not exposed to the narrow space 50, either. With this configuration, since the wire harness 110 and the circuit board are not exposed to the humidifying gas which flows through the narrow space 50, short circuits or corrosion due to the dew condensation to the wiring can be prevented. As illustrated in FIGS. 5 and 7, the ink supplied through the ink tube from the ink tank is introduced in the recording head unit 2 through a joint 52.

The housing 22 includes a hole 121 and a sealed holes. The wire harnesses 110 drawn from the plurality of recording head units 2 collectively pass through the hole 121. The ink tubes 112 pass through the sealed holes. The housing 22 is not necessarily provided and may be omitted.

With the recording apparatus described above, since the sheet is firmly held by a plurality of pairs of rollers, lifting of the sheet can be prevented even if the sheet is highly rigid and heavily curled. That is, sheets of any types or having any properties can be reliably supported during the process of introducing the humidifying gas between the recording heads and the sheet to prevent drying of ink nozzles. In addition, since the elastic members are sealingly disposed in the clearances between the recording head units and the holder and form an airtight seal, the humidifying gas can be used efficiently. Further, leakage of the humidifying gas can be reliably prevented even if the flow of the supplied humidifying gas is seriously disturbed by a roller when the sheet is held and conveyed by a pair of rollers near the recording position.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-106715 filed May 6, 2010, which is hereby incorporated by reference herein in its entirety.

What is claimed is:

1. An apparatus, comprising:
a first recording head unit and a second recording head unit arranged in a conveying direction, each of the recording head units including ink nozzles;
a conveying unit which includes a pair of rollers consisting of a first roller and a second roller, the pair of rollers holding the sheet between a recording position of the first recording head unit and a recording position of the second recording head unit, the first roller being disposed between the first and second recording head units;
a holder which holds the first and second recording head units;
a sealing member which is disposed in a clearance between the holder and at least one of the first and the second recording head units to form an airtight seal; and
a humidifying unit which supplies humidifying gas to a narrow space where the ink nozzles of the first and the second recording head units are exposed.

2. The apparatus according to claim 1, wherein the sealing member comprises an elastic members formed of a material different from that of the holder, capable of elastically being deformed.

3. The apparatus according to claim 1, wherein at least a part of the supplied humidifying gas flows through a space between the first recording head unit and the sheet being conveyed, a space between the first roller and the folder and a space between the second recording head unit and the sheet.

4. The apparatus according to claim 1, wherein:
the holder has a first opening in which the first recording head unit is inserted and a second opening in which the second recording head unit is inserted; and
the sealing member is disposed in a clearance between the first opening and the first recording head unit and a clearance between the second opening and the second recording head unit.

5. The apparatus according to claim 4, wherein:
a part of the sealing member is provided to surround a component of the holder disposed between the first and second openings; and
the sealing member contacts both a side surface of the first recording head unit which faces a side surface of the second recording head and the side surface of the second recording head unit which faces the side surface of the first recording head.

6. The apparatus according to claim 5, wherein the sealing member provided to surround the component of the holder disposed between the first and second openings is fixed to an upper surface and side surfaces of the component of the holder, the side surfaces of the component of the holder each facing the side surface of the first recording head unit and the side surface of the second recording head unit.

7. The apparatus according to claim 2, wherein:
the first and second recording head units each includes fixing sections for the fixation to the holder at both ends along a direction of a linear array of the ink nozzles;
the holder includes positioning sections provided at both ends of the first and second openings along the direction of the linear array of the ink nozzles;
the first and second recording head units are removably fixed to the holder with the fixing sections being positioned with corresponding positioning sections; and
the sealing member is disposed in a clearance between the fixed first opening and the first recording head unit and a clearance between the second opening and the second recording head unit to form an airtight seal.

8. The apparatus according to claim 1, wherein the sheet conveying unit includes a platen and the second roller is rotatably embedded in the platen.

9. The apparatus according to claim 1, further comprising a hygrometer which detects humidity of the gas near the second recording head in a space, wherein the humidifying unit is controlled based on a detection result of the hygrometer.

10. The apparatus according to claim 1, further comprising a return duct through which the humidifying gas moved from an upstream to a downstream in space is returned to the upstream.

11. The apparatus according to claim 1, wherein the first and second recording head units each includes a drawing port for drawing out wire harnesses at positions not exposed to the space.

12. The apparatus according to claim 11, wherein each recording head unit incorporates a circuit board which drives the ink nozzles and the wire harnesses are connected to the circuit board.

13. The apparatus according to claim 12, wherein each recording head unit includes a head portion provided with the ink nozzles and an ink tank in which ink is stored.
